(19) United States
(12) Patent Application Publication
(10) Pub. No.: US 2026/0056343 A1
(43) Pub. Date: Feb. 26, 2026

(54) METHODS AND SYSTEMS FOR PHASE SENSITIVE ELECTROMAGNETIC SENSING VIA PHYSICALLY SEPARATED TRANSMITTER AND RECEIVER MODULES

(71) Applicant: BATTELLE MEMORIAL INSTITUTE, Richland, WA (US)

(72) Inventors: MATTHEW S. TAUBMAN, West Richland, WA (US); ANTON S. SINKOV, Richland, WA (US)

(73) Assignee: BATTELLE MEMORIAL INSTITUTE, Richland, WA (US)

(21) Appl. No.: 19/307,831

(22) Filed: Aug. 22, 2025

Related U.S. Application Data
(60) Provisional application No. 63/685,989, filed on Aug. 22, 2024.

(51) Int. Cl. G01V 3/10; G01V 3/08

(52) U.S. Cl. CPC G01V 3/105; G01V 3/081; G01V 3/102; G01V 2200/12

(57) ABSTRACT

An electromagnetic induction (EMI) system for characterizing geophysical (e.g. subterranean) environments, includes: (a) a transmitter module including a transmission coil and signal transmission electronics; and (b) at least one receiver module including a receiver coil and signal reception electronics wherein the at least one receiver module is physically separated from the transmitter module without a wired signal connection between them, wherein phase information of signals sent by the transmitter module and those received by at least one receiver module are preserved such that phase information of received signals may be determined and used in characterizing the geophysical environment. In some systems, signal preservation uses a pair of correlated, stable, high frequency clocks.

### RELATED APPLICATIONS

This application claims benefit of U.S. Patent Application No. 63/685,989 filed Aug. 22, 2024. This referenced application is hereby incorporated herein by reference in its entirety including appendices and items incorporated therein by reference.

### STATEMENT AS TO RIGHTS TO INVENTIONS MADE UNDER FEDERALLY-SPONSORED RESEARCH AND DEVELOPMENT

This invention was made with Government support under Contract DE-AC0576RL01830 awarded by the U.S. Department of Energy. The Government has certain rights in the invention.

### BACKGROUND OF THE INVENTION

### Field of the Invention

The invention generally relates methods and systems for sending and receiving electromagnetic signals between a transmitter and at least one receiver wherein transmitter and at least one receiver are physically disconnected and galvanically isolated, and more particularly wherein phase and amplitude deviations resulting from conductive bodies between, or in the vicinity of, the transmitter and receiver are ascertainable without physical presence of a reference signal between the receiver and the transmitter. In some embodiments such receivers for such systems are land, water, or air drone mounted and used for geophysical characterization and monitoring based on electromagnetic induction within geophysical features that is induced by signals transmitted by the transmitter.

### Background Information

Geophysical methods are used increasingly to support characterization and monitoring challenges across the applied geosciences, including fossil energy exploration and development, mineral resource exploration and extraction, water resource management, contamination movement monitoring, and environmental remediation. Over the last two decades, geophysical research and development (R&D) has steadily evolved toward more rapid acquisition, processing, and delivery of results in efforts to make geophysical information more actionable and supportive of end users' needs. Perhaps the most active and transformative area of geophysical research today involves the application of new drone technologies in geophysical data acquisition, as evidenced by numerous special issues of journals, vision papers, and special journal sections devoted to the topic. Deployed as airborne, waterborne, and ground-based platforms for data acquisition and/or sampling, drones provide cost-effective access to remote areas, reduce risk to human operators, and allow for highly repeatable surveys. It has been suggested that drone-based geophysical surveys will achieve spatial data coverage approaching that of airborne/satellite-based geophysics while also achieving the resolution of ground-based geophysics. Tradeoffs between ground based geophysics, drone based geophysics, and airborne and satellite geophysics are conceptually illustrated in FIGS. 1A and 1B wherein FIG. 1A illustrates the domains of these three approaches in a plot of time required versus spatial data coverage while FIG. 1B shows resolution achievable vs spatial data coverage. FIGS. 1A and 1B were extracted from a journal article by Mangel, A. R., Dawson, C. B., Rey, D. M., and Briggs, M. A., entitled “Drone applications in hydrogeophysics: Recent examples and a vision for the future” published in The Leading Edge in August 2022 (https://doi.org/10.1190/tle41080540.1).

EMI geophysical surveys are offered commercially (e.g., see https://www.dronegeosci.com/); however, there has been a failure to fully capitalize on the use of drone technology in EMI. Currently, contractors rely on conventional EMI instrumentation, such as the Geophex GEM-2 from Geophex Ltd., which was developed for ground-based surveys as illustrated in FIG. 2A which shows a person walking with a GEM-2 device in the performance of a survey. In GEM-2 and similar instruments, the transmitter (Tx) and receiver (Rx) antennas (coils) are housed in the same unit or otherwise connected by cables to a common controller. GEM-2 devices have also been carried by drones during the performance of surveys. In usage, an oscillating current is driven at a specified frequency through one antenna coil (i.e., the transmitter). The current produces an alternating magnetic field which, in turn, induces voltages and current flow in subsurface regions as a function of its electrical conductivity (EC). FIG. 3 schematically illustrates a primary field inducing eddy currents. These induced currents produce secondary magnetic fields that, along with any primary field reaching the receiver are measured in the second antenna coil (i.e., the receiver). Based on the measured field and knowledge of the primary field, the EC of subsurface materials can be calculated. Using a range of frequencies and transmitter/receiver offsets and/or orientations provides information to spatially resolve subsurface EC structure. Because of the connected configuration of the GEM-2 transmitter and receiver usefulness of the such surveys have been limited.

Some limited use of drone-based surveying has been proposed involving the use of multiple drones as described in, for example, U.S. Pat. No. 10,845,498; however, as noted above, in practice, sensing of underground objects, such as metals, pipes, minerals and other conductive bodies is currently typically done using instruments with both transmitter and receiver in the same package or physically linked by cables, usually separated spatially by a few feet.

A need exists for improved versatility in such detection or geophysical characterization. A need exists for improved methods that can take advantage of phase sensitive survey methods in absence of cables or other galvanic connections that can be used to provide an understanding of phase between transmitters and receivers.

### SUMMARY

It is an object of some embodiments of the invention to provide geophysical characterization system using electromagnetic induction via signals sent from a transmitter module or platform to a receiver module or platform while detecting both phase and amplitude deviations at a receiver antenna due to interactions with metallic or other conductive bodies in the vicinity of the two platforms wherein the two platforms can move relative to each other and/or to the ground wherein there is not a galvanic connection between the platforms or at least no galvanic connection that can maintain or preserve phase knowledge between the platforms.

It is an object of some embodiments to provide relative movement between the transmitter and receiver platforms wherein the relative movement may take the form of one or more of translational movements while maintaining a given relative antenna orientation and/or varying relative orientation one antenna relative to the other and/or the orientation of each antenna relative to the vertical.

It is an object of embodiments of the invention to provide for high precision phase detection or correlation without the physical presence of a reference signal, which is classically necessary for such phase measurements. This advance greatly increases coverage, versatility and sensitivity of EM techniques.

It is an object of some embodiments, to allow operational spatial separations between transmission and reception antennae on the order of 10 feet or more, 50 feet or more, or even 100 feet or more, thus allowing much larger subsurface regions of the earth to be examined during the transmission and detection process.

It is an object of some embodiments to use multiple receivers with one transmitter with subsequent improvements in data integrity and speed of acquisition. In some embodiments multiple transmitters may be used with one or more receivers. In some embodiments where multiple transmitters are being used, tailored transmission and detection periods may be implemented while in others, use of different transmission waveforms or frequencies may be used.

It is an object of some embodiments to allow separate system parts (e.g., transmitter(s) and receiver(s)) to be mounted to convenient carriers or vehicles, such as ground based, flying, or floating vehicles that may be manned or unmanned (e.g., drones). For example, in some embodiments one of the parts may be mounted in a stationary manner while another is mounted in a moveable manner.

It is an object of some embodiments to provide for transmitter and/or receiver modules with low weights (e.g. under 1.5 Kgs) to allow transportation using drones with low payload capacity.

It is an object of some embodiments to provide systems that allow operations of receivers and transmitters that lack line of sight positioning or are otherwise physically isolated from one another.

It is an object of some embodiments to provide for phase preservation using an independent clock operating as part of each platform with frequencies and stabilities sufficient to ensure preservation of phase or at least calculated preservation of phase. In some embodiments, clocks may have their phases synchronized at the beginning of an uninterrupted period of transmission and detection (e.g., during a data acquisition process).

It is an object of some embodiments to provide a clock as part of one of the transmitter or the receiver modules that provides information to a clock on the other of the receiver or the transmitter module with information that provides for phase preservation.

It is an object for some embodiments where a clock of at least one of the transmitter or receiver modules is GPS informed and more preferably where both clocks are GPS informed.

It is an object of some embodiments to provide clocks that operate at at least twice the maximum frequency of a signal sent by the transmitter. In other embodiments, the clock frequency may exceed 4, 8, 16, 32, 64, or even 128 times that of the maximum frequency signal sent by the transmitter.

It is an object of some embodiments to provide a clock operating with a stable frequency that varies from nominal by no more than 100 parts per billion (ppb), no more than 50 ppb, even more preferably no more than 20 ppb, even more preferably no more than 10 ppb, and most preferably no more than 5 ppb.

It is an object of some embodiments to provide clocks that are vibrationally, temperature change, pressure change, and/or humidity change resistant or stabilized such that changes that occur during system operation do not cause phase preservation failure. For example, in some embodiments the system modules may be configured for providing stable clock operation within an environmental temperature range of −20 to +50° C., in some embodiments up to +85° C., and in some embodiments to at least −40° C.

It is an object of some embodiments to provide clocks that are MEMS clocks, atomic clocks, rubidium clocks, or other clocks that operate at frequencies greater than 10 MHz and more preferably at 25 MHz or more.

In a first aspect of the invention, an electromagnetic induction (EMI) system for characterizing geophysical environments, includes: (a) a transmitter module including a transmission coil and signal transmission electronics; and (b) at least one receiver module including a receiver coil and signal reception electronics wherein the at least one receiver module is physically separated from the transmitter module without a wired signal connection between them, wherein phase information of signals sent by the transmitter module and those received by the at least one receiver module is preserved such that phase information may be used in characterizing the geophysical environment.

Numerous variations of the first aspect of the invention exist and include, for example: (1) the first aspect wherein the transmitter module and the at least one receiver module together include clocks operating at frequencies and having accuracies no less than that necessary to enable sufficient preservation of the phase information for its use in characterizing the geophysical environment; (2) the first variation including the clocks being GPS informed clocks; (3) the first variation including the frequencies of the transmitter module clock and the at least one receiver clock being substantially the same; (4) the third variation wherein any variation in clock frequencies over a time period of interest do not significantly impact phase preservation; (5) the fourth variation wherein the time period of interest is an uninterpreted test time; (6) any of the third to fifth variations wherein the clocks are GPS informed; (7) the first variation wherein the frequencies of the transmitter module clock and the at least one receiver module clock are not substantially the same; (8) the seventh variation wherein phase preservation is maintained by applying a correction to information coming from at least one of the clocks; (9) either of the seventh or eighth variations wherein the clocks are GPS informed.

Additional variations of the first aspect of the invention exist and include, for example: (10) any of the first to ninth variations wherein the clocks have operating frequencies selected from the group of: (1) at least 2 times a maximum transmitter frequency of a signal sent by the transmitter module that is to be received by the receiver coil of the at least one receiver module; (II) at least 4 times greater than a maximum transmitter frequency of a signal sent by the transmitter module that is to be received by the receiver coil of the at least one receiver module and used in characterizing the geophysical environment; (Ill) at least 8 times greater than a maximum transmitter frequency of a signal sent by the transmitter module that is to be received by the receiver coil of the at least one receiver module and used in characterizing the geophysical environment; (IV) at least 16 times greater than a maximum transmitter frequency of a signal sent by the transmitter module that is to be received by the receiver coil of the at least one receiver module and used in characterizing the geophysical environment; (V) at least 32 times greater than a maximum transmitter frequency of a signal sent by the transmitter module that is to be received by the receiver coil of the at least one receiver module and used in characterizing the geophysical environment; (VI) at least 64 times greater than a maximum transmitter frequency of a signal sent by the transmitter module that is to be received by the receiver coil of the at least one receiver module and used in characterizing the geophysical environment; and (VII) at least 128 times greater than a maximum transmitter frequency of a signal sent by the transmitter module that is to be received by the receiver coil of the at least one receiver module and used in characterizing the geophysical environment; (11) any of the first to tenth variations wherein the clocks have operating frequency relationships including at least one relationship selected from the group of: (1) frequencies of the clocks are not integer multiples of an operating frequency of a transmitted signal, (II) a frequency of the clock of the at least one receiver module is asynchronous with the respect to a frequency of the clock of the transmitter module, (Ill) a frequency of the clock of the at least one receiver module is independent of an operating frequency of a transmitted signal; and (IV) a frequency of the clock of the at least one transmitter module is independent of an operating frequency of a transmitted signal.

Additional variations of the first aspect of the invention exist and include, for example: (12) any of the first—eleven variations wherein the clocks include stable clocks; (13) the twelfth variation wherein the stable clocks operate with signal variations of less than 50 parts per billion; (14) any of the first to thirteenth variations wherein at least one of the clocks is a vibration resistant clock that is configured to provide stable operation in the presence of vibration that may occur during operational usage of the system; (15) any of the first to fourteenth variations wherein at least one of the clocks is configured to provide stable operation in the presence of any environment temperature variations that occur during operational usage of the system; (16) the fifteenth variation including a temperature control unit that includes at least one element selected from the group consisting of: (I) a heater and (II) a cooler which controls the temperature of the clock; (17) any of the first to sixteenth variations wherein at least one of the clocks is configured to provide stable operation in the presence of any environmental pressure variations that occur during operational usage of the system; (18) any of the first to seventeenth variations wherein at least one of the clocks is configured to provide stable operation in the presence of any environmental humidity variations that occur during operational usage of the system; (19) any of the first to the eighteenth variations wherein at least one of the clocks includes a phase lock loop; and (20) the nineteenth variation wherein the at least one clock that includes a phase lock loop is a MEMS clock that includes a MEMS resonator.

Still additional variations of the first aspect of the invention exist and include, for example: (21) any of the first to eighteenth variations wherein at least one of the clocks include a MEMS clock; (22) the twenty-first variation wherein each of the transmitter clock and the at least one receiver clock include a MEMS clock; (23) any the first to twentieth variations wherein at least one of the clocks includes an atomic clock; (24) the twenty-third variation wherein the atomic clock includes a rubidium clock; (25) any of the first to twenty-fourth variations wherein the operating frequency of the clock is greater than 10 MHz with a stability more accurate than 10 parts per billion; (26) any of the first to twenty-fifth variations wherein the transmitter module, during use, is supported by a medium selected from group consisting of: (1) a solid (e.g. the earth), (II) a gas (e.g. the air), and (111) a liquid (e.g. on a body of water or in a body of water); (27) the twenty-sixth variation wherein the transmitter module is supported by an unmanned aerial vehicle (UAV); (28) the twenty-seventh variation wherein the UAV is controlled autonomously; (29) the twenty-seventh variation wherein the UAV is controlled manually by an operator; (30) any of the first to twenty-nineth variations wherein the receiver module, during use, is supported by a medium selected from group consisting of: (1) a solid (e.g. the earth), (II) a gas (e.g. the air), and (Ill) a liquid (e.g. on a body of water or in a body of water); (31) the thirtieth variation wherein the receiver module is supported by an unmanned aerial vehicle (UAV); (32) the thirty-first variation wherein the UAV is controlled autonomously; (33) the thirty-second variation wherein the UAV is controlled manually by an operator; (34) any of the first to thirty-third variations wherein the receiver module, during use, moves, at least a portion of the time, relative to the transmitter module; (35) any of the first to thirty-third variations wherein the receiver module, during use, moves, at least a portion of the time, relative to the earth; (36) any of the first to thirty-third variations wherein the transmitter module, during use, moves, at least a portion of the time, relative to the earth; (37) any of the first to thirty-third variations wherein the transmitter module and the at least one receiver module, during use, move, at least a portion of the time, relative to the earth; and (38) any of the first to thirty-third variations wherein the transmitter module and the at least one receiver module, during use, move, at least a portion of the time, relative to the earth while maintaining fixed positions relative to each other.

Further variations of the first aspect of the invention exist and include, for example: (39) the first aspect or any of the first to thirty-eight variations wherein the transmitter module and the at least one receiver module each include a wireless communication system; (40) the thirty-nine variation wherein the communication systems provide communication between at least some modules; (41) the first aspect or any of the first to fortieth variations additionally including a computer system that provides for communication with at least one of the transmitter module and the at least one receiver module; (42) the forty-first variation wherein communications between the computer system and the at least one of the transmitter module and the at least one receiver module occurs wirelessly; (43) the forty-first or forty-second variation wherein the computer system provides for a function selected from the group consisting of: (1) data storage, (II) data analysis, (111) user input and output, (IV) EMI system control, and (V) module movement; (44) any of the forty-first to forty-third variations wherein the system is configured to provide real-time data analysis; (45) the forty-fourth variation wherein the real-time data is provided within tens of minutes of data acquisition; (46) the forty-fifth variation wherein the real-time data is provided within minutes of data acquisition; (47) any of the forty-first to forty-sixth variations wherein the system is programmed to provide for real-time data visualization; (48) any of forty-first to forty-seventh variations wherein the computer system is programmed to provide for adaptive surveying wherein an initial survey plan is modified mid-survey in response to geophysical results that are obtained; (49) the first aspect of any of first to forty-eight variations wherein the transmitter module and the at least one receiver module each include a GPS and at least one spatial orientation sensor (which is coordinated to the orientation of respective coil) which provides data for use in providing the geophysical characterization; (50) the forty-fourth variation wherein the GPS and spatial orientation data associated with the transmitter module (e.g. coordinated with the transmitter coil orientation) and the GPS and spatial orientation data associated with the at least one receiver module (e.g. coordinated with the receiver coil orientation) are used in compensating for any difference in orientation between the transmitter module and the at least one receiver module; and (51) either of the forty-nineth or fiftieth variations, wherein the GPS data associated with the transmitter module and the GPS data associated with the at least one receiver module are used in compensating for any difference in elevation of the transmitter module and the at least one receiver module.

Still further variations of the first aspect of the invention exist and include, for example: (52) the first aspect or any of the first to fifty-first variations wherein transmitter module further includes a power amplifier that feeds the transmitter coil via an in-series resonating capacitor; (53) the first aspect or any of the first to fifty-second variations wherein the receiver coil of the at least one receiver module sends received signals to an amplifier via an in-parallel resonating capacitor; (54) the fifty-third variation of the first aspect wherein said in-parallel resonating capacitor is adjusted during operation to peak the response of the resulting parallel resonant circuit, consisting of the in-parallel resonating capacitor and the receiver coil; (55) the first aspect or any of the first to fifty-fourth variations wherein the system is configured for operation when the transmitter module and at least one of the at least one receiver module are separated by a distance selected from the group consisting of: (1) more than 10 feet during at least a portion of data gathering, (II) more than 20 feet during data at least a portion of data gathering, (Ill) more than 60 feet during at least a portion of data gathering, and (IV) more than 100 feet during at least a portion of data gathering; (56) the first aspect or any of the first to fifty-fifth variations wherein the system is configured for operation without a line of sight between the transmitter module and at least one of the at least one receiver module during at least a portion of data gathering; (57) the first aspect or any of the first to fifty-sixth variations wherein the at least one receiver module includes N receiver modules that independently use signals from the transmitter module wherein N is selected from the group consisting of: (I) at least 2, (II) at least 3, (III) at least 5, (IV) at least 7, and (V) at least 10; (58) the fifty-seven variation wherein at least 2 of the receiver modules are capable of operating simultaneously to produce data for providing the geophysical characterization; (59) the first aspect or any of the first to fifty-eighth variations wherein the at least one transmitter module includes M transmitter modules wherein M is at least 2; and (60) the fifty-ninth variation, as it depends from either the fifty-seventh or fifty-eighth variation wherein the M modules are capable of operating simultaneously to transmit signals that can be received by at least one of the at least N receiver modules so as to produce data for providing the geophysical characterization.

In a second aspect of the invention an electromagnetic induction (EMI) method for characterizing geophysical environments, includes: (a) providing an EMI system, including (i) a transmitter module including a transmission coil and signal transmission electronics; (ii) providing at least one receiver module including a receiver coil and signal reception electronics wherein the at least one receiver module is physically separated from the transmitter module without a wired signal connection between them; (b) operating the EMI system for data gathering (c) preserving phase information of signals sent by the transmitter module and received by the at least one receiver module during data gathering; and (d) using the preserved phase information in characterizing the geophysical environment.

Numerous variations of the second aspect of the invention exist and include, for example: (1) the second aspect wherein the transmitter module and the at least one receiver module together include clocks operating at frequencies and having accuracies no less than that necessary to enable sufficient preservation of the phase information for its use in characterizing the geophysical environment, and wherein the method includes using the clocks during data gathering; (2) the first variation including the clocks being GPS informed clocks; (3) the first variation including the frequencies of the transmitter module clock and the at least one receiver clock being substantially the same; (4) the third variation wherein any variation in clock frequencies over a time period of interest do not significantly impact phase preservation; (5) the fourth variation wherein the time period of interest is an uninterpreted test time; (6) any of the third to fifth variations wherein the clocks are GPS informed; (7) the first variation wherein the frequencies of the transmitter module clock and the at least one receiver module clock are not substantially the same; (8) the seventh variation wherein phase preservation is maintained by applying a correction to information coming from at least one of the clocks; (9) either of the seventh or eighth variation wherein the clocks are GPS informed.

Additional variations of the second aspect of the invention exist and include, for example: (10) any of the first to ninth variations wherein the clocks have operating frequencies selected from the group consisting of: (i) at least 2 times a maximum transmitter frequency of a signal sent by the transmitter module that is to be received by the receiver coil of the at least one receiver module; (ii) at least 4 times greater than a maximum transmitter frequency of a signal sent by the transmitter module that is to be received by the receiver coil of the at least one receiver module and used in characterizing the geophysical environment; (iii) at least 8 times greater than a maximum transmitter frequency of a signal sent by the transmitter module that is to be received by the receiver coil of the at least one receiver module and used in characterizing the geophysical environment; (IV) at least 16 times greater than a maximum transmitter frequency of a signal sent by the transmitter module that is to be received by the receiver coil of the at least one receiver module and used in characterizing the geophysical environment; (V) at least 32 times greater than a maximum transmitter frequency of a signal sent by the transmitter module that is to be received by the receiver coil of the at least one receiver module and used in characterizing the geophysical environment; (VI) at least 64 times greater than a maximum transmitter frequency of a signal sent by the transmitter module that is to be received by the receiver coil of the at least one receiver module and used in characterizing the geophysical environment; and (VII) at least 128 times greater than a maximum transmitter frequency of a signal sent by the transmitter module that is to be received by the receiver coil of the at least one receiver module and used in characterizing the geophysical environment; (11) any of the first to tenth variations wherein the clocks have operating frequency relationships including at least one relationship selected from the group of: (1) frequencies of the clocks are not integer multiples of an operating frequency of a transmitted signal, (II) a frequency of the clock of the at least one receiver module is asynchronous with the respect to a frequency of the clock of the transmitter module, (III) a frequency of the clock of the at least one receiver module is independent of an operating frequency of a transmitted signal; and (IV) a frequency of the clock of the at least one transmitter module is independent of an operating frequency of a transmitted signal.

Additional variations of the second aspect of the invention exist and include, for example: (12) any of the first variation to the eleventh variations wherein the clocks include stable clocks; (13) the twelfth variation wherein the stable clocks operate with signal variations of less than 50 parts per billion; (14) any of the first variation to the thirteenth variations wherein at least one of the clocks is a vibration resistant clock that is configured to provide stable operation in the presence of vibration that may occur during operation of the method in gathering a data set, wherein the data set is used in providing the geophysical characterization; (15) any of the first variation to the fourteenth variations wherein at least one of the clocks configured to provide stable operation in the presence of any environment temperature variations that occur during operational usage of the method in gathering a data set, wherein the data set is used in providing the geophysical characterization; (16) the fifteenth variation including a temperature control unit that includes at least one element selected from the group consisting of: (1) a heater and (2) a cooler, and operating the temperature control unit during data gathering to control a temperature of the clock; (17) any of the first variation to the sixteenth variations wherein at least one of the clocks is configured to provide stable operation in the presence of any environmental pressure variations that occur during operational usage of the method; (18) any of the first variation to the seventeenth variations wherein at least one of the clocks is configured to provide stable operation in the presence of any environmental humidity variations that occur during operational usage of the method; (19) any of the first variation to the eighteenth variations wherein at least one of the clocks includes a phase lock loop; and (20) the nineteenth variation wherein the at least one clock that includes a phase lock loop is a MEMS clock that includes a MEMS resonator.

Still additional variations of the second aspect of the invention exist and include, for example: (21) any the first to eighteenth variations wherein at least one of the clocks includes a MEMS clock; (22) the twenty-first variation wherein each of the transmitter clock and the at least one receiver clock include a MEMS clock; (23) any the first to twentieth variations wherein at least one of the clocks includes an atomic clock; (24) the twenty-third variation wherein the atomic clock includes a rubidium clock; (25) any of the first to twenty-fourth variations wherein the operating frequency of the clock is greater than 10 MHz with a stability more accurate than 10 parts per billion; (26) any of the first to eighteenth variations wherein the transmitter module, during use, is supported by a medium selected from group consisting of: (1) a solid (e.g. the earth), (2) a gas (e.g. the air), and (3) a liquid (e.g. on a body of water or in a body of water); (27) the twenty-sixth variation wherein the transmitter module is supported by an unmanned aerial vehicle (UAV); (28) the twenty-seventh variation wherein the UAV is controlled autonomously; (29) the twenty-seventh variation wherein the UAV is controlled manually by an operator; (30) any of the first to twenty-nineth variations wherein the receiver module, during use, is supported by a medium selected from group consisting of: (1) a solid (e.g. the earth), (II) a gas (e.g. the air), and (111) a liquid (e.g. on a body of water or in a body of water); (31) the thirtieth variation wherein the receiver module is supported by an unmanned aerial vehicle (UAV); (32) the thirty-first variation wherein the UAV is controlled autonomously; (33) the thirty-second variation wherein the UAV is controlled manually by an operator; (34) any of the first to thirty-third variations additionally including relatively moving the receiver module and the transmitter module at least a portion of the time during data gathering; (35) any of the first to thirty-third variations 4 wherein the moving of receiver module relative to earth at least a portion of the time during data gathering; (36) any of the first to thirty-third variations additionally including moving the transmitter module relative to earth at least a portion of the time during data gathering; and (37) any of the first to thirty-third variations additionally including moving the transmitter module and the at least one receiver module at least a portion of the time during data gathering relative to the earth; and (38) any of the first to thirty-third variations additionally including moving the transmitter module and the at least one receiver module at least a portion of the time during data gathering relative to the earth while maintaining fixed positions relative to each other.

Further variations of the second aspect of the invention exist and include, for example: (39) the second aspect or any of the first to thirty-eight variations wherein the transmitter module and the at least one receiver module each include a wireless communication system; (40) the thirty-nine variation wherein the communication systems provides communication between at least some modules; (41) the second aspect or any of the first to fortieth variations additionally includes a computer system that provides for communication with at least one of the transmitter module and the at least one receiver module; (42) the forty-first variation wherein communications between the computer system and the at least one of the transmitter module and the at least one receiver module occurs wirelessly; (43) the forty-first or forty-second variation wherein the computer system provides for a function selected from the group consisting of: (1) data storage, (II) data analysis, (111) user input and output, (IV) EMI system control, and (V) module movement; (44) any of the forty-first to forty-third variations wherein the EMI system is configured to provide real-time data analysis; (45) the forty-fourth variation wherein the real-time data is provided within tens of minutes of data acquisition; (46) the forty-fifth variation wherein the real-time data is provided within minutes of data acquisition; (47) any of the forty-first to forty-sixth variations wherein the real-time data analysis provides real-time data visualization; (48) any of forty-first to forty-seventh variations wherein the EMI system is programmed to provide for adaptive surveying wherein an initial survey plan is modified mid-survey in response to geophysical results that are obtained; (49) the second aspect of any of first to forty-eight variations wherein the transmitter module and the at least one receiver module each include a GPS and at least one spatial orientation sensor (which is coordinated to the orientation of respective coil) which provides data for use in providing the geophysical characterization; (50) the forty-fourth variation wherein the GPS and spatial orientation data associated with the transmitter module (e.g. coordinated with the transmitter coil orientation) and the GPS and spatial orientation data associated with the at least one receiver module (e.g. coordinated with the receiver coil orientation) are used in compensating for any difference in orientation between the transmitter module and the at least one receiver module; and (51) either of the forty-ninth or fiftieth variations wherein the GPS data associated with the transmitter module and the GPS data associated with the at least one receiver module are used in compensating for any difference in elevation of the transmitter module and the at least one receiver module.

Still further variations of the second aspect of the invention exist and include, for example: (52) the second aspect or any of the first to fifty-first variations wherein transmitter module further includes a power amplifier that feeds the transmitter coil via an in-series resonating capacitor; (53) the second aspect or any of the first to fifty-second variations wherein the receiver coil of the at least one receiver module sends received signals to an amplifier via an in-parallel resonating capacitor; (54) the fifty-third variation of the second aspect wherein said in-parallel resonating capacitor is adjusted during operation to peak the response of the resulting parallel resonant circuit, consisting of the in-parallel resonating capacitor and the receiver coil; (55) the second aspect or any of the first to fifty-fourth variations additionally including gathering data when the transmitter module and at least one of the at least one receiver module are separated by a distance selected from the group consisting of: (1) more than 10 feet during at least a portion of data gathering, (II) more than 20 feet during data at least a portion of data gathering, (Ill) more than 60 feet during at least a portion of data gathering, and (IV) more than 100 feet during at least a portion of data gathering; (56) the second aspect or any of the first to fifty-fifth variations additionally including gathering data when there is no line of sight between the transmitter module and at least one of the at least one receiver modules that is providing data; (57) the second aspect or any of the first to fifty-sixth variations wherein the at least one receiver module includes N receiver modules that independently use signals from the transmitter module wherein N is selected from the group consisting of: (I) at least 2, (II) at least 3, (III) at least 5, (IV) at least 7, and (V) at least 10; (58) the fifty-seventh variation wherein at least 2 of the receiver modules are capable of operating simultaneously to produce data for providing the geophysical characterization; (59) the second aspect or any of the first to fifty-eighth variations wherein the at least one transmitter module includes M transmitter modules wherein M includes at least 2; and (60) the fifty-ninth variation, as it depends from either the fifty-seventh or fifty-eighth variation wherein the M modules are capable of operating simultaneously to transmit signals that can be received by at least one of the at least N receiver modules so as to produce data for providing the geophysical characterization.

In a third aspect of the invention an electromagnetic induction (EMI) system for characterizing geophysical environments, includes: (a) an EMI system, including: (i) a means for transmitting; (ii) a means for receiving that is physically separated from the transmitter module without a wired signal connection between them; (b) means for operating the EMI system for data gathering; (c) means for preserving phase information of signals sent by the means for transmitting and received by the means for receiving during data gathering; and (d) means for using the preserved phase information in characterizing the geophysical environment.

Numerous variations of the third aspect of the invention exist and will be apparent to those of skill in the art upon review of the teachings herein. Some such variations include the variations of the first aspect, mutatis mutandis.

Other objects and advantages of various aspects and embodiments of the invention will be apparent to those of skill in the art upon review of the teachings herein. The various aspects and embodiments of the invention, set forth explicitly herein or otherwise ascertained from the teachings herein, may address any one of the above objects alone or in combination, or alternatively may address some other object of the invention ascertained from the teachings herein. It is not intended that any specific aspect or embodiment of the invention (that is explicitly set forth herein or that is ascertained from the teachings herein) necessarily address any of the objects set forth above let alone address all these objects simultaneously, but some aspects and embodiments may address more than one of these objects simultaneously.

### BRIEF DESCRIPTION OF THE DRAWINGS

FIG. 1A and FIG. 1B depict tradeoffs of different types of surveying methods where FIG. 1A provides an illustration of time required for a geophysical survey versus spatial data coverage for these different methods, and FIG. 1B provides an illustration of resolution possible versus spatial data coverage for these different methods.

FIG. 2A and FIG. 2B provides photographs, respectively, of a man carrying a Geophex, Ltd GEM-2 instrument during a survey and a drone carrying a similar instrument during a survey (photographs from https://geophex.com/).

FIG. 3 provides a schematic illustration of the electromagnetic transmission of a primary field and production of eddy currents and a secondary field during operation of a horizontal coplanar frequency domain electromagnetic system.

FIG. 4A provides a schematic illustration of a system according to a first embodiment of the invention wherein the system comprises a single transmitter module and a single receiver module wherein the transmitter module contains electronics allowing phase preservation, signal transmission electronics, and a transmission coil while the receiver module similarly contains electronics allowing phase preservation, signal reception electronics, and a receiver coil.

FIG. 4B provides a block diagram of transmission module electronics of some embodiments of the invention with generalized data information flow shown along with some optional components/submodules/functionalities.

FIG. 4C provides a block diagram of receiver module electronics of some embodiments of the invention with generalized data information flow shown along with some optional components/submodules/functionalities.

FIG. 5A provides a photograph of most of the electronic elements of a receiver, module including the radio, RS-422 digital adapter, an analog to digital/microcontroller board, precision clock (CLK), digital synthesizer (DDS), and GPS.

FIG. 5B provides a photograph of a receiver platform, module, or rover taken before field testing which includes a 24- by 48-inch by ⅝-inch thick sheet of plywood, and components and/or submodules which are attached using plastic hardware.

FIG. 5C provides a block diagram of receiver electronics including functional connections and DC power requirements for individual functional components and/or submodules.

FIG. 6 provides an enlarged image of the 8 inch receiving coil of FIG. 5B.

FIG. 7 provides an image of an impedance analyzer's response of the coil of FIG. 6 showing a self-resonance of 298.5 kHz.

FIG. 8A provides a photograph of the Tx platform taken before field testing which includes a 38- by 68-inch by ⅝-inch thick sheet of plywood and electronic components and/or submodules attached using plastic hardware.

FIG. 8B provides a block diagram of the transmitter (Tx) electronics including functional connections and DC power requirements for individual functional components and/or submodules.

FIG. 8C provides a photograph of a capacitor box and internal capacitors used to create the desired resonating capacitor value for Tx platform.

FIG. 9 provides an image of an impedance analyzer's response of the coil of FIG. 8A showing a self-resonance of 90.83 kHz.

FIG. 10 provides a screen capture of a GUI for measurement acquisition and control and real-time visualization of data acquired via an EMI system or method of the present invention.

FIG. 11 provides a screen capture of the digital object description for a HDF5 database in which the drone data are organized.

FIG. 12 provides a photograph of field test setup, showing a transmitter platform with a large black coil and no wheels, a receiver platform (i.e. board with wheels and a guide rope), and a field laptop.

FIG. 13 provides a plot of raw data collected from a transect line in a field test including signal magnitude, imaginary and real components at each point along a longitudinal line with the transmitter at a midway point along a transect (i.e., where magnitude is greatest) where the effect of two metal targets is clearly visible.

FIG. 14 a photograph of during a field test at PNNL's Richland, WA facility showing the field laptop in the foreground displaying the GUI, the transmitter in the midground, and roving Rx cart in the background.

FIG. 15 provides a plot of observed EMI data as a collected during a field test, a primary field based on an analytical model, and the difference between the two which shows the secondary field in absence of the primary field.

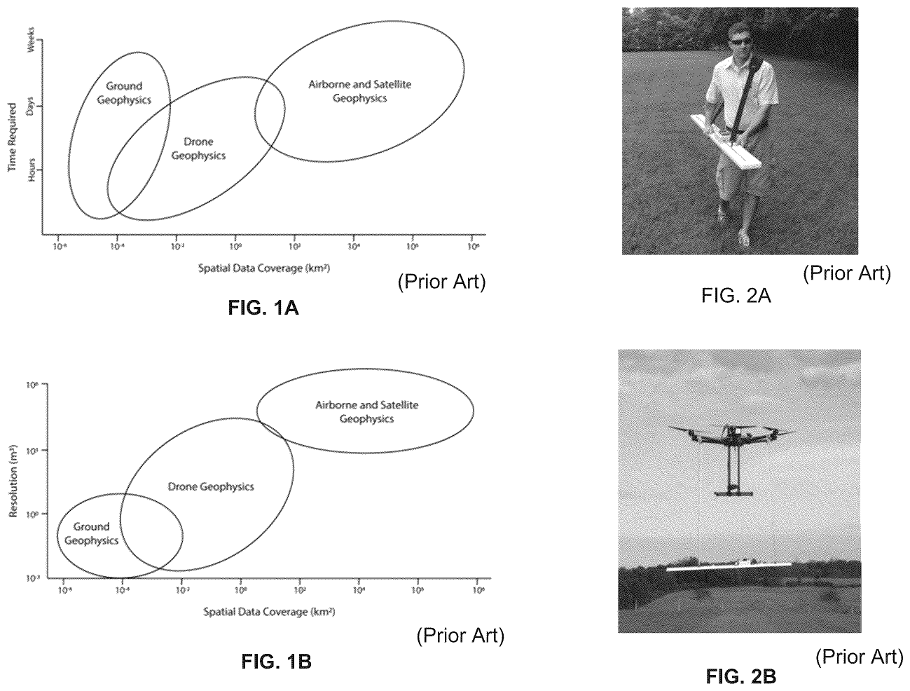

### DETAILED DESCRIPTION OF EMBODIMENTS OF THE INVENTION

Various advantages and novel features of the present invention are described herein and will become even further apparent to those skilled in this art from the following detailed description. In the preceding and following descriptions the preferred embodiment of the invention is shown by way of illustration of the best mode contemplated for carrying out the invention along a number of variations. As will be realized, the invention is capable of modification in various respects without departing from the spirit of the invention as will be understood by those of skill in the art.

### Acronyms, and Abbreviations, and Definitions

3D: Three-dimensional
Q: Ohm/Ohms
μF: microfarads
ADC: Analog to digital converter
AWG: American wire gauge
Cap: Capacitor
CLK: Clock
COTS: Commercially available off-the-shelf
DC: Direct current
DDS: Direct digital synthesis, and/or digital synthesizer board
DOI: Depth of investigation
EC: Electrical conductivity
EMF: Electromotive force
EMI: Electromagnetic induction
GPS: Global positioning system
GUI: Graphical user interface
HDF5: Hierarchical data format 5
IN AMP: Instrumentation amplifier
kHz: Kilohertz
MEMS: Micro Electronic Mechanical Systems
mH: Millihenries
MHz: Megahertz
nF: nanofarads
OEM: Original Equipment Manufacturer
pF: Picofarads
PNNL: Pacific Northwest National Laboratory
R&D: Research and development
Rx: Receiver
SOM: System on module
TCP: Transmission communication protocol
Tx: Transmitter
UAS: Unoccupied aerial systems
VSP: Visual Sample Plan

In this document, the terms “a” or “an” are used, as is common in patent documents, to include one or more than one, independent of any other instances or usages of “at least one” or “one or more.”

In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.”

Also, in the following claims, the terms “including” and “comprising” are open-ended, that is, a system, device, article, or process that includes elements in addition to those listed after such a term in a claim are still deemed to fall within the scope of that claim.

As used herein a receiver platform or receiver module includes both receiver electronics and a receiver antenna which are functionally coupled. In some variations the platform may include a single rigid support that holds all components, functional modules or devices while in other variations movement between components, functional modules or devices may be allowed such as when a platform includes a drone that carries some components, functional modules or devices rigidly held to a body of the drone while dangling an antenna and possibility other components, functional modules, devices from the drone to provide a desired level of isolation or reduced interference.

As used herein a transmitter platform or receiver module includes both transmit electronics and a transmit antenna which are functionally coupled. In some variations the platform may include a single rigid support that holds all components, functional modules or devices while in other variations movement between components, functional modules or devices may be allowed such as when a platform includes a drone that carries some components, functional modules or devices rigidly held to a body of the drone while dangling an antenna and possibility other components, functional modules, devices from the drone to provide a desired level of separation, for example, for electronic, maneuverability, or other deployment reasons.

As used herein module generally refers to a self-contained group of electronic components and/or submodules that are together capable performing a desired function or group of functions. Submodule and module have similar meanings with the distinction that a submodule and its function or functions form a portion of a larger module that contains additional submodules and/or components that provide the module with additional functionality. A submodule can be considered a module when higher level grouping are not being referenced while modules may be considered submodules when higher level grouping associated therewith are being referenced.

In this document, the term component, device, module, circuit board, assembly or the like may refer to a single electronic or electrical element, a group of combined electronic or electrical elements that perform one or more functions. In any given implementation, a function or functions indicated as being performed by a single component, device, module, circuit board, or the like, may instead be performed by a combination of such components, devices, modules, circuit boards, or the like operating together to achieve the function unless the context strictly and unambiguously forbids such implementation. Similarly, a function or functions indicated as being performed by multiple components, devices, modules, circuit boards, or the like may alternatively be formed by a single such component, device, module, circuit board, or the like unless the context strictly and unambiguously forbids such implementation.

As used herein “real-time” or “near-real-time” refer to data processing that yields preliminary results in a time period that is less than a survey data gathering time such that the preliminary results, if warranted, can be used to modified survey plans or parameters while the survey is still on going. In some implementations, real-time results may be returned within minutes, within tens of minutes, or within one hour or more.

### Generalized Embodiments of the Invention

The frequency-domain EMI method is commonly used for mapping and/or imaging near-surface (a few tens of meters) EC variations, and the closely related controlled-source electromagnetic method (CSEM) is used for imaging deeper (10s to 100s of meters).

Both the depth of investigation (DOI) for EMI and the resolution attained depend on the instrument's operating frequencies, the inter-coil spacing or spacings and relative orientations, and the EC of the earth materials. Data collected at larger inter-coil spacings or with lower frequency signals, sample larger volumes of the earth at lower spatial resolutions, and are thus sensitive to deeper, broader structures. Conversely, data collected with smaller inter-coil spacings or higher frequency signals, sample over smaller volumes and better resolve near-surface EC variations. DOI is also a function of the EC of soil or rock, with more signal decay in materials of higher EC.

Multi-frequency EMI data can be inverted to produce 2D cross sections or 3D volumes of subsurface EC; however, it is more common to plot data for a single frequency or subset of frequencies or convert multi-frequency data to “total electrical conductivity” for interpretation.

In principle, UAS-based EMI can allow for fully airborne (i.e., airborne Tx and Rx) or semi-airborne (i.e., ground-based Tx, airborne Rx) configurations. Deeper investigations may require more powerful and heavy Tx, precluding fully airborne surveys. In these cases, the Tx may be ground-based and moved by field operators or manned or autonomous ground vehicles, or it could be carried by drones and thus ‘hop’ between locations

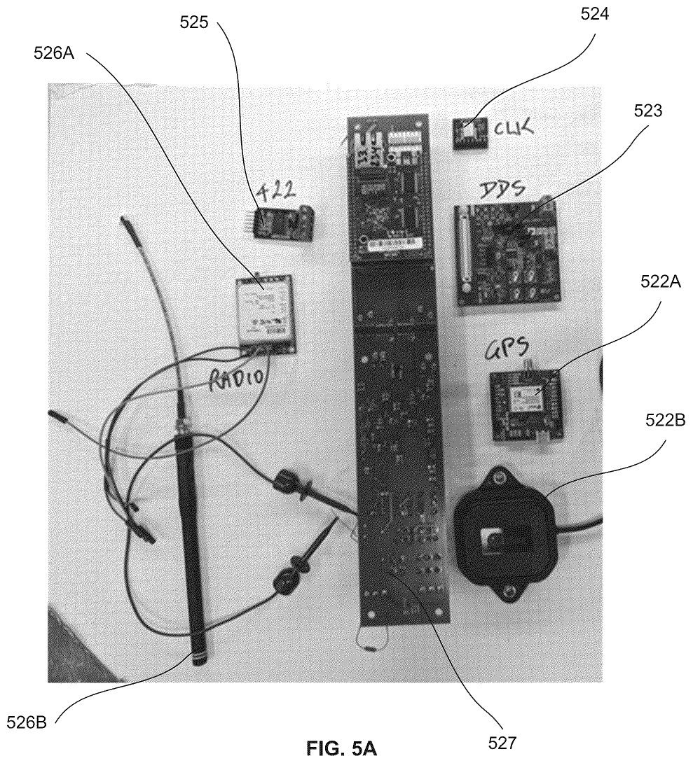

FIG. 4A provides a schematic illustration of a system according to a first embodiment of the invention wherein the system comprises a single transmitter platform or module and a single receiver platform or module wherein the transmitter module contains electronics allowing phase preservation, signal transmission electronics, and a transmission coil while the receiver module similarly contains electronics allowing phase preservation, signal reception electronics, and a receiver coil.

FIG. 4B provides a block diagram of example transmission platform electronics with indicators of generalized data, signal, or information flow, and with some optional components/submodules/functionalities being shown. These example electronic components, groups of components, or submodules may be used in some embodiments of the invention while other embodiments may use alternative elements and signal flow schemes. As indicated, one submodule or component group is at least one signal processor and module controller. This controller can take signals and receive signals from a number of sources as shown by the directional arrows extending therefrom or thereto where the solid lines show basic connections while the dashed lines indicate optional connections. As illustrated the signal processor and module controller is/are responsible for providing signals to an electromagnetic power amplifier which in turn provides those signals to a transmission coil via a resonating capacitor that is connected in series with the coil. In some variations, the resonating capacitor may be capable of providing variable capacitance via an adjustment actuator or switch that is controlled by the module controller. Such variable control may be used to optimize coil output. In different variations, the adjustment actuator or switch may provide a mechanical adjustment of the capacitance or alternatively it may provide an electronic adjustment.

A stable, high frequency clock is provided which, in some variations, may include internal or external synchronization and stabilization features that may be implemented via sensors and control elements that may accommodate one or more of environmental temperature changes, pressure changes, humidity changes, and the like.

In some variations the clock may be informed via signals received from GPS input. In some embodiments, the primary purpose of the GPS data may be to provide positioning and/or orientation information without a need for providing updated clock signals or to otherwise correlate clock signals with GPS time signals.

The transmitter module electronics may also include a transceiver, that may be used in association with any appropriate carrier, for sending and receiving signals or communications via analog or digital radio, optical, or other means. In some cases, where wired connections are possible, signals may be transferred galvanically or inductively. In some embodiments, the communications may be between the transmitter module and the receiver module while in other cases the communications may be directly with a monitoring computer or some other device. The module may also include one or more appropriate power sources such as, for example, batteries, fuel cells, solar panels, wired connections, and the like. In some embodiments, a single power source may be used with appropriate regulators to provide one or more voltage level to meet power requirements of different components. In some embodiments, the electronics may include data storage capability. In some embodiments user interface capability may be included. It may be as simple as an on-off switch or settable dip switches. An output device may be included and take any of a variety of forms, such as for example, one or more lights, a display monitor, a speaker, or the like. In some cases an input device may be included and take any of a variety of forms, including for example one or more of a keyboard, a mouse, a touch screen, a microphone, a remote control, or the like, In some embodiments where the transmission module or platform, or one or more submodules thereof, is/are capable of self-propelled movement or reorientation, one or more actuators and actuator controllers may be included. Such devices may be controlled manually or autonomously via the at least one signal processor and module controller, with or without additional motion sensors, interface devices, or feedback components or modules. In some variations, sensors and motional controllers may be used to automatically inhibit or reduce the impact of unintended motions such as tilting or swinging of a coil/antenna when suspended from a drone.

FIG. 4C provides a block diagram of receiver platform electronics of some embodiments of the invention with generalized data information flow shown along with some optional components/submodules/functionalities. These example electronic components, groups of components, or submodules may be used in some embodiments of the invention while other embodiments may use alternative elements and information flow schemes. As with the transmission module, one submodule or component of the receiver module or platform is at least one signal processor and module controller. This controller can take signals and receive signals from a number of sources as shown by the directional arrows extending therefrom or thereto where the solid lines show basic connections while the dashed lines indicate optional connections. As illustrated the signal processor and module controller is/are responsible for receiving signals from an electromagnetic power amplifier which in turn receives signals from a transmission coil via a resonating capacitor that is connected in parallel with the coil. In some variations, the resonating capacitor may be capable of providing variable capacitance via an adjustment actuator or switch that is controlled by the module controller. Such variable control may be used to optimize received input from the coil relative to a given output from the transmission module. Such adjustments may be made in real time by holding the two components in fixed positions and the transmission power steady while varying the capacitance and monitoring the received signal strength. In different variations, the capacitance adjustment actuator or switch may provide a mechanical adjustment of the capacitance or alternatively it may provide an electronic adjustment.

A stable, high frequency clock is provided which, in some variations, may include internal or external synchronization and stabilization features that are implemented via sensors and control elements that may accommodate one or more of environmental temperature changes, pressure changes, humidity changes, and the like.

In some variations the clock may be informed via signals received from GPS input. In some embodiments, the primary purpose of the GPS data may be to provide positioning and/or orientation information without a need for providing updated clock signals or to otherwise correlate clock signals with GPS time signals.

One function of the transmitter platform clock and the receiver platform clock is to provide for phase preservation such that variations in phase that are detected can be attributed to geo geophysical characteristics of a region being evaluated. As such, the clocks may be made to operate stably with sufficient phase correlation over a period of interest (e.g., a testing period, an operational battery use period between recharges, a period greater than 20 minutes, a period greater than 1 hour, or in some embodiments even a period greater than 2 hours) to ensure adequate correlation is maintained. In some embodiments, adequate correlation may be considered to exist when an actual phase difference or calculated phase difference has not exceeded 0.1 degrees, in other embodiments it has not exceeded 0.2 degrees, has not exceeded 0.5 degrees, or in some cases even higher degree variations may be tolerated if phase preservation is adequate. In some variations, the clocks need not operate with matched phases or even unvarying phase differences, so long as the difference in phase between the two clocks at any given time can be calculated and used in making phase correlation evaluations.

In some embodiments, the primary purpose of the GPS data may be to provide positioning and/or orientation information without a need for providing updated clock signals or to otherwise correlate clock signals with GPS time signals. In some variations, the GPS signals may be used for both purposes.

The receiver module electronics may also include a transceiver, that may be used in association with any appropriate carrier, for sending and receiving signals or communications via analog or digital radio, optical, or other means. In some cases, where wired connections are possible, signals may be transferred galvanically or inductively. In some embodiments, the communications may be between the receiver module and the transmitter module while in other cases the communications may be directly with a monitoring computer. The module also include one or more appropriate power sources such as, for example, batteries, fuel cells, solar panels, wired connections, and the like. In some embodiments, the electronics may include data storage capability. In some embodiments user interface capability may be included. It may be as simple as an on-off switch or settable dip switches. An output device may be included and take any of a variety of forms, such as for example, one or more lights, a display monitor, a speaker, or the like. In some cases an input device may be included and take any of a variety of forms, including for example one or more of a keyboard, a mouse, a microphone, a remote control, or the like, In some embodiments where the receiver module or platform is capable of self-propelled motion or reorientation, one or more actuators and actuator controllers may be included. Such devices may be controlled manually or autonomously via the at least one signal processor and module controller, with or without additional motion sensors, interface devices, or feedback components or modules. In some variations, sensors and motional controllers may be used to automatically inhibit or reduce the impact of unintended motions such as tilting or swinging of a coil/antenna when suspended from a drone.

In variations of the above system, multiple receiver modules may be used simultaneously with a single transmitter module. Alternatively multiple transmitters and receivers may be used in the field at the same time particularly when the transmitters operate at offset times and/or operate with different frequencies or wave forms such that detected signals may be correlated with a particular transmitter module.

### Example Implementation—Instrumentation Hardware

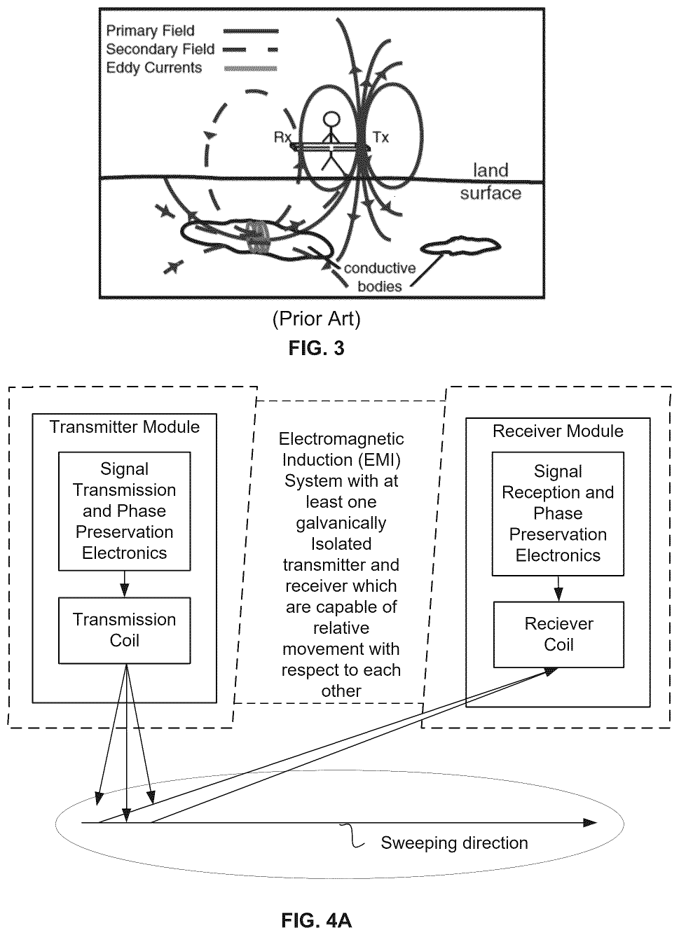

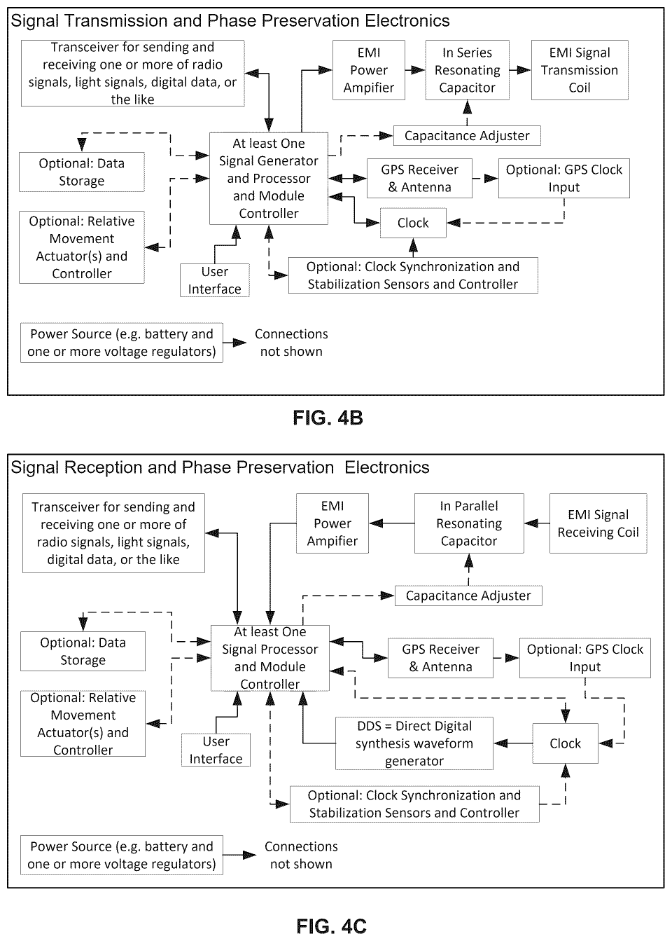

In conventional EMI instrumentation (e.g., as shown in FIGS. 2A and 2B), physical connections between Tx and Rx units readily allow for precise timing of signal transmission and reception using shared electronics for a common timing system. Although this ‘umbilical’ approach has posed no significant disadvantages to the standard practice of EMI, it is highly problematic for drone-based deployments and other employments where umbilical attachment is cumbersome or otherwise impractical. To this end, two independent platforms were developed, one for transmission and the other for reception or measurement. In this example, the Tx platform also served as the “base” in that the laptop used in the system, serving as the operations and data center, connected directly to the Tx platform, which was physically stationary during data gathering. The Rx module, or roving module, was mounted on a platform with wheels. It reported information via radio link to the transmitter and then to laptop. The laptop could in interface with either the Tx platform or the Rx platform via the Tx platform.

As it was desirable for both Rx and Tx platforms to minimize interference, metal was minimized in their fabrication. This was particularly important as it was intended that coil-to-coil interactions (i.e., EMI antennae interactions) occur at considerable distances (e.g. 10s of meters, or more) To this end, plywood sheets were used as the basic structure, with plastic hardware for securing subassemblies. Since these platforms were relatively large, the electronics were mounted on smaller plywood boards in each case, which could be easily removed and worked on during development and testing. In other implementations, other materials and/or configurations may be used that further separate the electronic modules from their respective antennae, for example, electronic components may be mounted or otherwise positioned significantly above the coils when regions of interest are located below the antennae.

When two coil-based antennas of this kind couple together as in this demonstration, the received signal by one from the other falls off as the reciprocal of separation distance cubed (ie., 1/d³). This presents one of the principal challenges with the idea of separating transmitter and receiver—providing adequate drive and reception signal strength. This implies that the transmitter has to be powerful, and the receiver has to be sensitive. Thus, in the transmitter, a high-power drive amplifier is required. In the receiver, a sensitive differential instrumentation amplifier is preferred (IN AMP) to achieve good signal to noise ratio. An additional practical functionality of interest, is the ability for the IN AMP to reduce its gain when the platforms are in close proximity (to avoid overload conditions) and increase it when further they are further apart (to retain sensitivity).

Furthermore, under these signal constraints it's difficult to achieve good coupling using just the bare reactance of such coils—it's logistically difficult to drive a bare Tx coil hard enough because its inductive reactance gets in the way. In a complementary way, a receiver using a bare coil develops relatively little voltage in response to a magnetic signal because of the same phenomenon, but in the opposite sense—the coil's impedance is too low. To overcome these problems, both the Tx and Rx drive systems can use resonant systems to optimize the performance in each case: the current is maximized in the transmitter and the observed electromotive force (EMF) is maximized in the receiver. Resonating the selected coils (e.g. with appropriate capacitors) can bring significant practical benefits. Further explanation of resonances can be found in Chapter 6 of the ARRL Handbook, published by the National Association for Amateur Radio, and many books on basic electronics.

In general, surveys done with EMI instruments may be conducted over a range of frequencies in order to facilitate geophysical inversion in order to produce an image. Indeed, commercial units operate over a considerable frequency range, typically below 100 Hz out to 100 kHz or more and it should be understood that such multi-frequency testing could be beneficially used with the system embodiments of the present invention. For the present implementation, only one operating frequency was chosen. This chosen frequency was 3.052 kHz though other frequencies could have been selected and used. This selection avoided the need for complex switching systems on both Tx and Rx platforms while still allowing demonstration of both hardware and software capability.

### Receiver Platform (Rover)

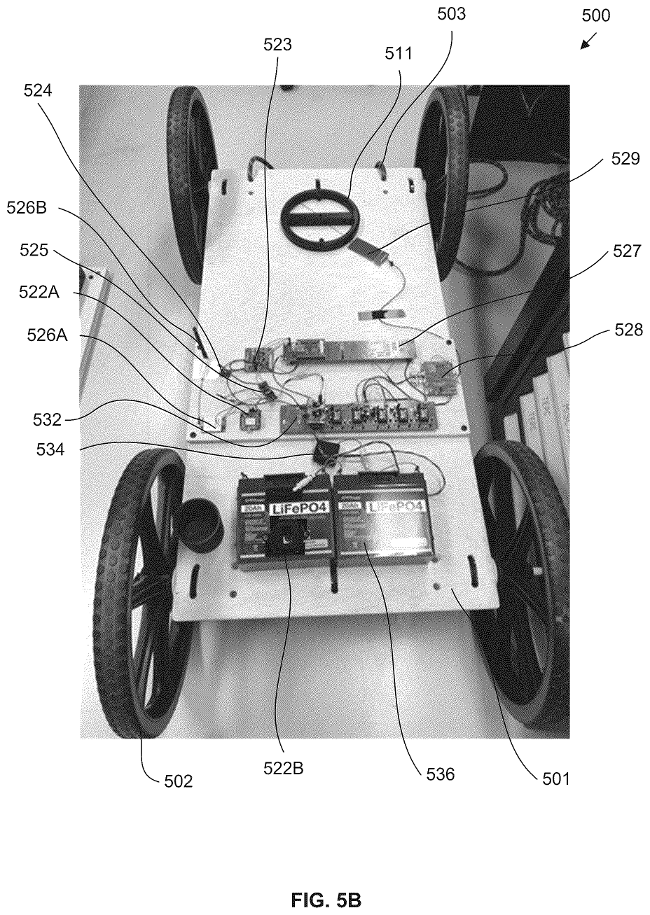

FIG. 5A provides a photograph of the components/submodules that make up most of an Rx electronics subassembly with the primary exceptions of a second instrumentation precision differential amplifier 528 (i.e., an IN AMP, such as an LTC6373 from Analog Devices), a power distribution board 532, an on/off switch which are shown in FIG. 5B. In FIG. 5B the IN AMP is shown as part of an LTC6373 development/evaluation kit. The components/subassemblies shown in FIG. 5A include a GPS unit 522A (e.g. a UBLOX GPS) and its antenna 522B (e.g. a GNSS antenna), a digital synthesizer board (DDS) 523, a precision MEMS-based clock (CLK) 524, an RS-422 digital comms unit 525 which functions a transceiver for wired communication, and a radio 526A (e.g., a FreeWave radio) and its antenna 526B used for wireless communicating with the transmitter platform, system laptop, or other system monitor/controller/interface. The large north-south oriented circuit board shown in the middle is a signal processing board 527. This signal processing board contains an analog-to-digital converter (ADC), an instrumentation precision differential amplifier, electrical isolators and a NetBurner microcontroller unit, which is used to compute signal amplitude and real and imaginary components, incorporate GPS data, and manage data flow and communications.

FIG. 5B provides a photograph of the receiver platform 500. The platform board 501 (24 by 48 inches) is mobile in that it sported four large plastic wheels 502 allowing it to be pulled back and forth across a field test site using two long lengths of rope 503. The ⅝″ plywood platform supported subcomponents that were attached using plastic hardware. At the top of the board, as shown is a receiver coil (aka antenna) 511 which is connected to the electronic components/submodules of FIG. 5A via a circuit board 529 that holds one or more capacitors that are enaged in parallel with the coil and an amplifier 528. Also shown in FIG. 5B is the signal processing board or submodule 527 (i.e., the upper of the two long circuit boards) as shown in FIG. 5A and various other electronic components/submodules that are shown also shown in FIG. 5A. FIG. 5B also shows a power distribution board or submodule 532 (i.e, the lower of the two long boards) which includes fuses, regulators, switch-mode voltage converters. This distribution board provides specific voltages with over-current protection to various components/submodules. FIG. 5B also depicts an on/off power switch 534 as well as batteries 536.

The functional connections of the electronic components of the receiver platform or module are further illustrated in FIG. 5C. Signals from coil 511 at the desired operating frequency (e.g., 3 kHz) are preferentially selected by the resonance of the coil and a parallel capacitor (mounted on the small blue circuit board 529 next to the coil). These signals are passed to the precision instrumentation amplifier 528 (e.g. the IN AMP forming part of the LTC6373 dev. kit discussed above). The output from the IN AMP is passed to the ADC on the signal processing board 527, thence to the NetBurner via electrical isolators which provides a digitized version of the received signal waveform.

In parallel with this, the DDS 523 produces a low-jitter sampling pulse train to trigger the ADC of the signal processing board 527 at precise points in time, allowing a similar system on the transmitter platform to be correlated with this process and effectively preserve phase information between the two platforms. This process is achieved through use of a precision MEMS clock (e.g. a SIT5721 from SiTime) which was set to operate at 25 MHz with a stability from nominal within 5 parts per billion (5 ppb). This unit is also relatively immune to physical vibration, making it useful for drone-based systems. It's also temperature controlled using an onboard oven inside the chip. In this way, the use of two such clocks allows the two platforms to determine phase shifts without a physical umbilical connecting the two.

In addition, the onboard GPS system gives time-stamped GPS coordinates, which are also included in data packets sent to the Tx platform (which holds the laptop) via the microprocessor/microcontroller of the signal processing unit 527 and the radio unit 526A, for acquisition, storage and processing via the laptop computer.

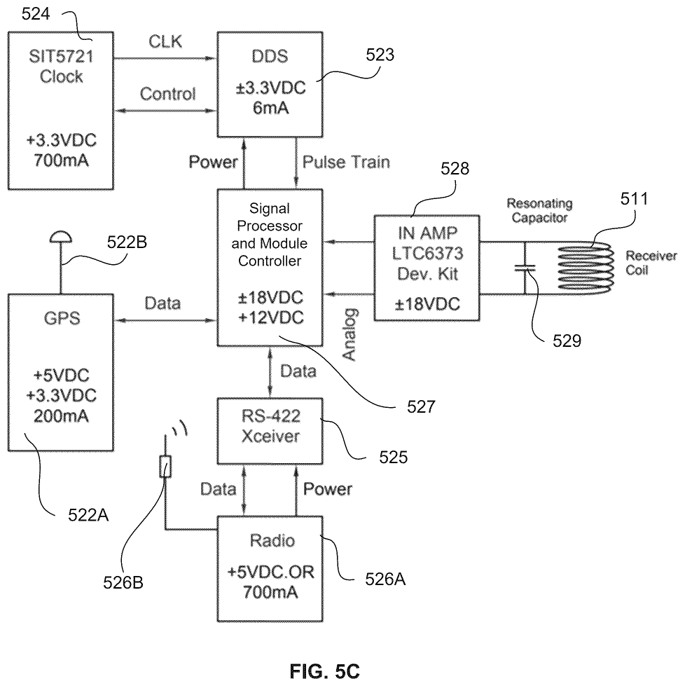

FIG. 6 provides an enlarged photograph of the receiver coil 511. The coil was an 8-inch 3D printed unit, wound with 18-AWG enameled copper magnet wire. To optimize performance, winding of the coil was performed to keep the self-resonance of the coil at as high a frequency as possible as coils cannot be used effectively for their intended purposes at frequencies above this. Thus, the effective interwinding capacitance must be kept to a minimum which requires a regular tidy coil winding of cross sections with minimal incidence of breakthrough from one layer to more than one below it.

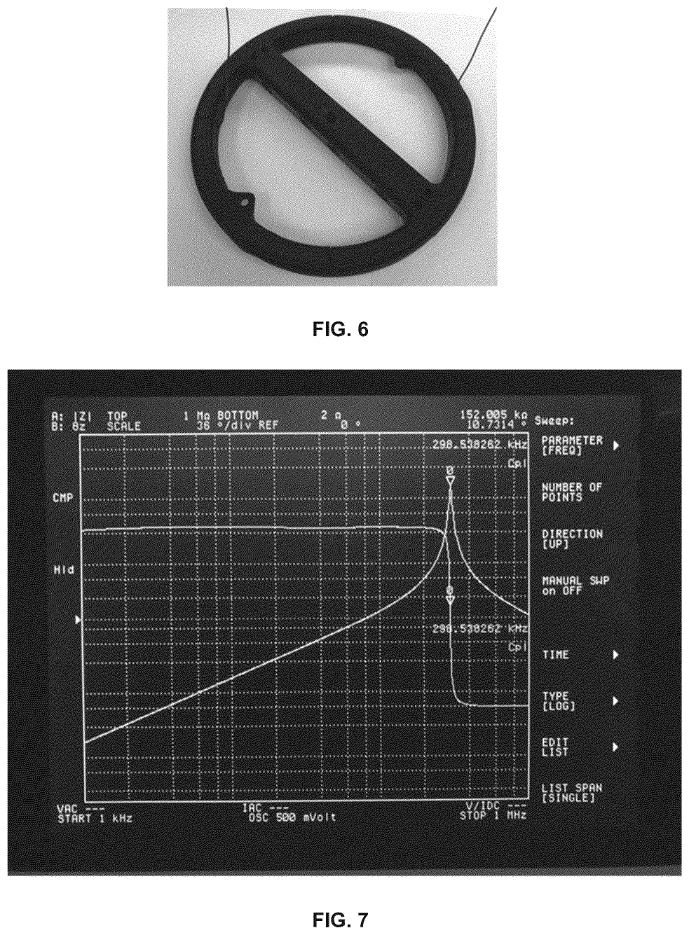

FIG. 7 shows the impedance analyzer response of the finished receiver coil of FIG. 6 showing a self-resonance at 298.5 kHz. Effective operation must be well below this frequency for good signal to noise ratio. This coil formed an excellent receiver at 3 kHz.

The final Rx coil of FIG. 5B and FIG. 6 included 82.5 turns of 18-AWG wire, had an inductance of 2.67 milliHenries (mH), a DC resistance of 1.09Ω, and a self-resonance of 298.5 kHz. This implies an effective self-resonating capacitance of 106.5 pF which is not a real capacitance, but an ‘effective’ one. Resonating this coil at 3.052 kHz required a capacitance of 1.018 μF. Accommodating the effective self-capacitance of the coil, it was found that a 1 μF orange drop capacitor worked just fine as the resonating capacitor.

### Transmitter (Base)

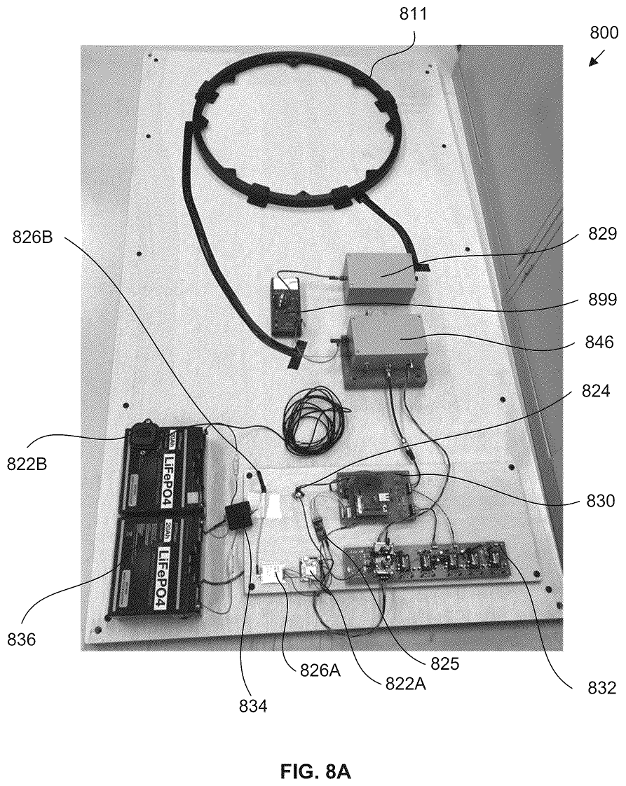

A photograph of the Tx platform 800 is shown in FIG. 8A. This platform includes electronics mounted to a 38 by 68 inch by ⅝ inch plywood base. A laptop was used to control the system (not shown) and was connected directly to the electronics board of this platform via an Ethernet cable. As can be seen, some of the components or submodules of the Tx platform are similar to those of the Rx platform with the differences resulting from the different functionalities intended for each platform. The Tx platform includes a large antenna coil 811, a resonating capacitor box 829B which provides one or more capacitors in a series connection to the coil with the coil and resonating capacitor receiving transmission signals from signal processing and control board 830 via a power amplifier unit 846. Board 830 provides multiple functions with some being similar to those board 527 of FIGS. 5A-5C. The functions provided by board 830 include signal generation; incorporation of GPS data, signal processing (e.g., measurement of amplitude and phase relative to the top of the GPS seconds); management of data flow; and management of communications with the receiver platform and the laptop or ground station computer. The transmitter platform also includes a power distribution board 832 which is similar to power distribution board 532 on the receiver platform. The transmission platform also includes batteries 836, and a power switch 834, a clock 824, a transceiver 825, a radio 826A, a radio antenna 826B, a GPS receiver 822A, and a GPS antenna 822B. A current sensing meter 899 is also shown on the platform which is for testing purposes.

The functional connections of the electronic components or submodules of the transmitter platform or transmitter module are further illustrated in FIG. 5C. A signal generation, data processing and control board, of submodule 830 provides some functions similar to those of board 527 but additionally synthesizes a precision sinusoidal waveform (e.g. at 3.052-kH) for transmission by coil 811. In other embodiments, other frequency waveforms may be generated. The synthesized waveform is supplied to the power amplifier submodule 846 and then to the transmitter coil 811 via an in series resonating capacitor 829. The power amplifier submodules 846 includes a circuit board, a power amplifier, input and output ports, an external heatsink on its backside (not shown), and various inputs as well as an on-off switch.

The signal generator function is informed once again by a precision MEMS clock (an SIT5721 clock) 824 which is the same as the clock 524 of the receiver platform. Communication signals are received from radio 522A of the Rx platform 500 (including its GPS information) by radio antenna 822B and radio unit 822A and sent to the RS-422 transceiver and are thereafter combined with transmitter platform 800 information (including its own GPS information) to form the final data packet stream that can be passed to the a system base or laptop or other local or remote processor via, for example, a wired connection or via radio communication using transceiver module 825, radio module 826A, and antenna 826B.

FIG. 8C provides a photograph of the capacitor box 829B providing a plurality of capacitors combined to provide a desired net capacitance forming part of the transmission circuitry via a series connection between the amplifier and the Tx coil. Contained within the box is a non-metal circuit board supporting three parallel banks of series capacitors, ultimately connected to banana plug jacks on the outside of the box. In this example, each of the three parallel capacitor banks consists of a series string of two capacitors. Two of these series include two 220-nF caps, while the smaller central one includes two 47-nF caps. This yielded a total capacitance of 243.5 nF. This configuration was selected because series resonances of coils can result in quite high voltages, sometimes up to 300V peak. Since the ratings of the capacitors (600V) is a DC rating, and typical AC ratings are lower (e.g., around 250V), multiple series capacitors are required to minimize risk of failure. Furthermore, the above example AC ratings are only for 60 Hz with the stress on capacitors being much worse at higher frequencies, like the 3 kHz frequency of the current implementation. The above noted capacitance value was selected based on the parameters of coil 811 as discussed next.

The coil 811 of the Tx platform has a diameter of 24 inches and didn't have 3D printed cross members. The coil included 81.3 turns of 18-AWG enamel coated wire. It was carefully wound so layers of turns contacted an immediately preceding layer but did not penetrate it (i.e. slip-downs were avoided), as slip downs tend to greatly reduce the usability of the coil at higher frequencies as explained above.

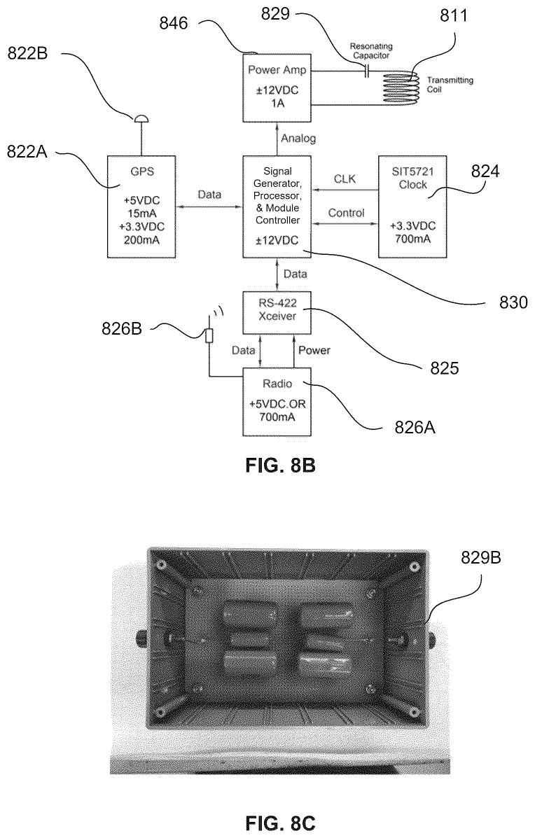

FIG. 9 shows the self-resonance of 90.83 kHz as determined by an impedance analyzer for the finished Tx coil. As with the Rx coil, effective operation must be below this frequency. However, this turns out to be more stringent in this case, and frequency used must in fact be well below this frequency. This is because the Tx coil is resonated in series, not parallel, and correct operation depends on a low ohmic (real part) of the impedance upon resonance. By comparison, the parallel resonance of the Rx system operates at a high impedance point, and a little more real impedance doesn't matter. Not all of this real impedance term comes from actual DC resistance, but rather, seems to manifest itself as other loss terms related to a finite Q-value. Surmounting this in our demonstration would have required much larger drive voltages and unnecessary heating of components. Q-values, in general, climbed as test frequencies increased. At high values it became impractical to resonate the coil precisely at the narrow resonances produced. The operating frequency of 3 kHz was chosen but this coil could have operated at up to about 10 kHz.

The final Tx coil characteristics include: 81.3 turns of 18-AWG wire; inductance of 11.27 milliHenreys (mH); DC resistance of 3.45Ω; self-resonance of 90.83 kHz. This implies an effective self-resonating capacitance of 272.4 pF which is not a real capacitance but an ‘effective’ one. Resonating this coil at 3 kHz required use of a resonating capacitance capacitance close to 243.5 nF as provided in capitance box 829B.

The batteries 536 and 836 chosen as power sources for the Rx and Tx platforms respectively were of the lithium iron phosphate (LiFePO₄) type. These are very robust, safe, high capacity and most importantly light-weight batteries. This made them a good choice for this implementation, even though they are relatively large compared to other choices, such as lithium-ion batteries. Space and size were not tightly constrained as can be seen in FIGS. 5B and 8A. Had drone-based flight been pursued, more compact lithium-ion batteries would have been selected.

### Operational Software

Both platforms used a NetBurner MODM7AE70 system-on-module (SOM) as part of its signal processing module (i.e. 527 for the Rx platform and 830 for the Tx platform). This is a very convenient unit allowing processing and comms in an accessible and convenient manner. To wit, the receiver firmware programmed onto the NetBurner on the Rx platform processes received signal waveforms to compute a cartesian phasor representation of the received signal. The results are then combined with position and time information provided by the GPS module to form Rx data packets, which were then transmitted via radio to the transmitter module which in turn provided packets to the laptop for further analysis.

In standard EMI practice, data are collected and quality-checked in the field, but rarely are data fully worked up until after completion of a field campaign. This practice has been judged to be cost-effective in the past. For ground-based surveys, it has been cost-effective to focus labor on data collection while staff are still in the field. It is believed that capabilities of some embodiments of the present invention can enable not only enhanced data gathering but also real-time data analysis sufficient to enable adoption of modified survey schemes based on real-time survey results as they are occurring either automatically, by decisions of onsite survey monitors, or offsite survey monitors who are seeing real time results that warrant further data acquisition. In some such implementations, incoming data may be fed to trained AI algorithms that yield real-time preliminary conclusions that warrant actionable changes in immediate survey plans or scheduling of follow on survey actions.

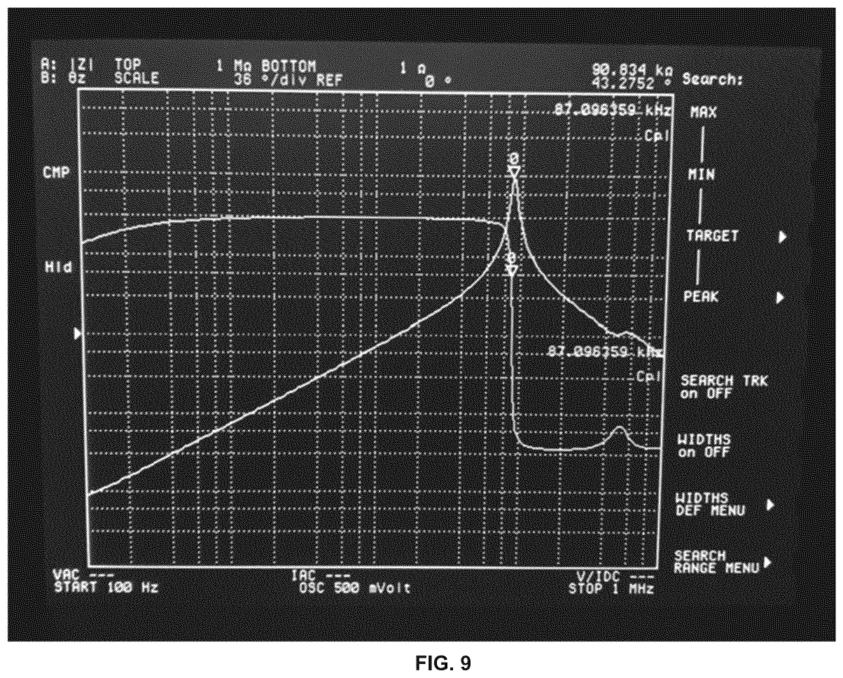

Software developed in this project included python code for data acquisition, data management, and real-time visualization of raw and processed data. This work leveraged the existing code base of PNNL's VSP software which includes functionality for visualization and statistical analysis; this allows field operators to gain real-time insight into datasets as data are acquired. The HDF5 database format was adopted for data management. A graphical user interface (GUI) was developed with a screen shot shown in FIG. 10 using the Kivy package in Python, providing the user with a straightforward means of initializing the HDF5 file with user-input metadata, establishing a data connection between the field laptop and the instrument using the Transmission Control Protocol (TCP), and parsing data packets into data arrays that can be processed in small chunks and viewed in real-time. Packaging the code into a GUI helped ensure that the various components of the software worked together seamlessly. The GUI includes a plotting tab that populates map-view plots of raw and processed data as the sensor moves through the survey area. Removal of the primary field to isolate the induced field is done geometrically using data from orientation sensors on the loops to correct for tilting of the magnetic field created by the Tx and for the change in vertical flux caused by tilting of the Rx, as well as real-time kinematic GPS for relative positional accuracy within centimeters. Orientation and position information are updated 10 times per second to ensure accurate removal of the primary field with every data sample.

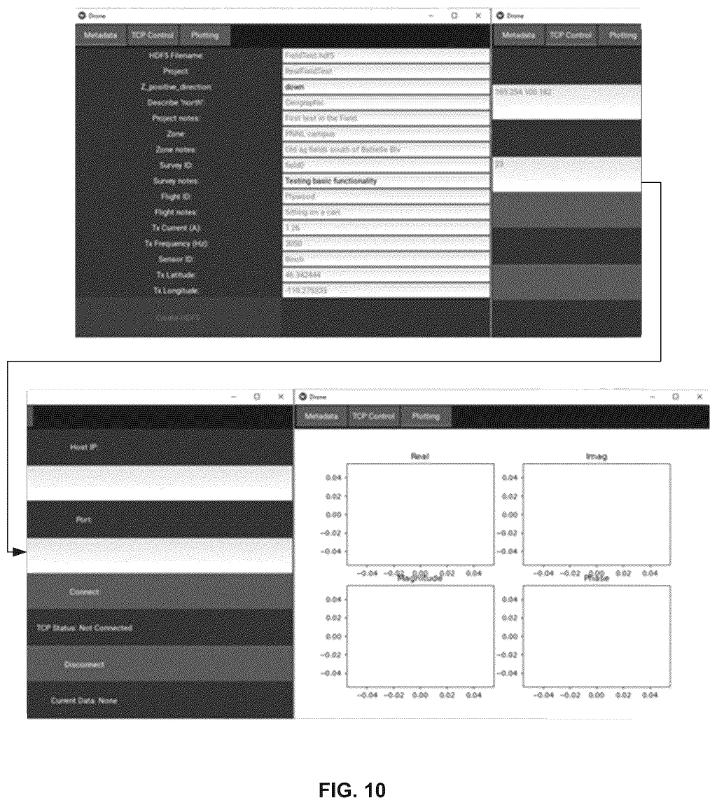

The use of the HDF5 format allows for all of the information for a project to be stored in a single file. Data are organized in a hierarchical format with a screen shot shown in FIG. 11 of various zones within each project, different surveys within each zone, and individual flights within each survey. Parameters related to the sensors and drones are also saved. HDF5 is a flexible format that allows for expansion as future needs are identified. The format is widely used across many industries, with many existing software libraries designed to quickly access the data on any platform, whether on a local machine or in cloud-based processing.

### Initial Field Demonstration

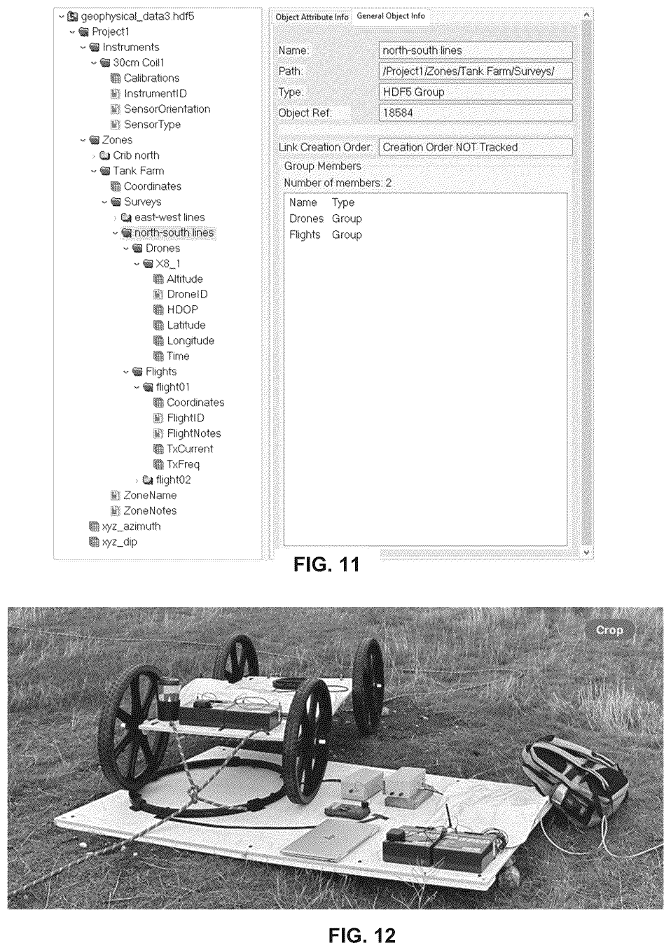

A field test was conducted on PNNL's campus in Richland, Washington to test the new hardware and software components in realistic conditions. As explained above, given practical constraints on flying the prototype components, which were yet to be miniaturized, a ground-based initial demonstration was conducted. As discussed above, a custom base (transmitter platform 800) and a rover (receiver platform 500) were designed and fabricated and are shown in combination ready for field testing in FIG. 12.

The test site was an open field with two metal targets (i.e., jacketed extension cords) placed in the study area. Using ropes secured to the front and back of the cart, PNNL staff pulled the receiver across the study site.

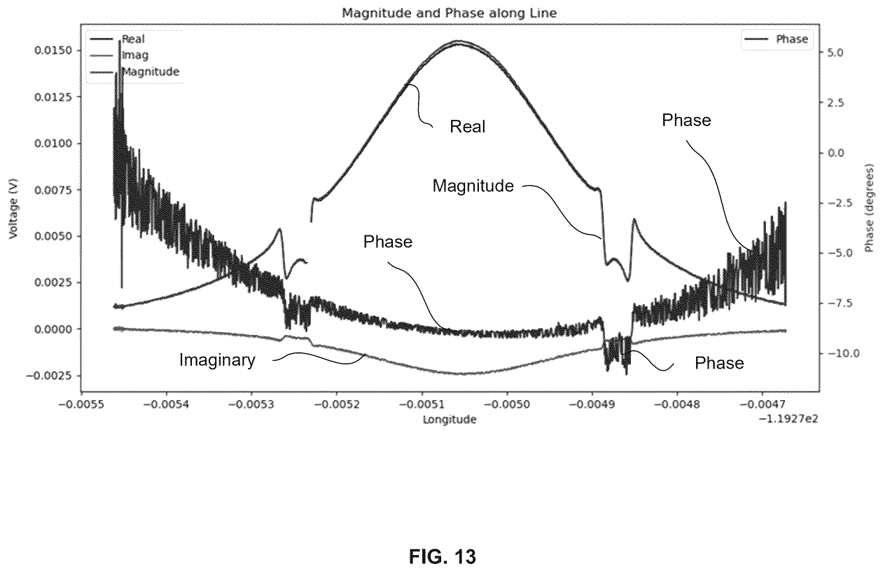

Using a field laptop, EMI measurements were acquired. Data were continuously transmitted via radio link from both the Rx platform and Tx platform to the laptop (which was wired to the Tx platform) for integration into the HDF5 database, along with GPS information for the rover position. The raw data was displayed as a magnitude as well as real and imaginary components as exemplified in FIG. 13 which clearly show the effect of the metallic targets, as well as the dominant effect of the primary field generated by the transmitter.

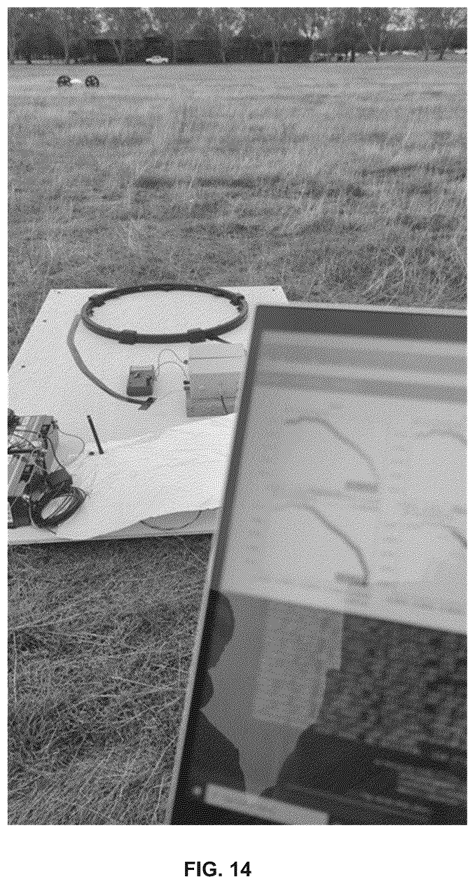

Notably, this information was processed and visualized in real-time, with user-friendly displays of data being supplied to field operators via the field laptop. This is depicted in the photograph of FIG. 14, in which the Tx platform can be seen in the foreground along with the laptop showing data visualization diagrams with the movable Rx platform in the distant upper left portion of the photograph.

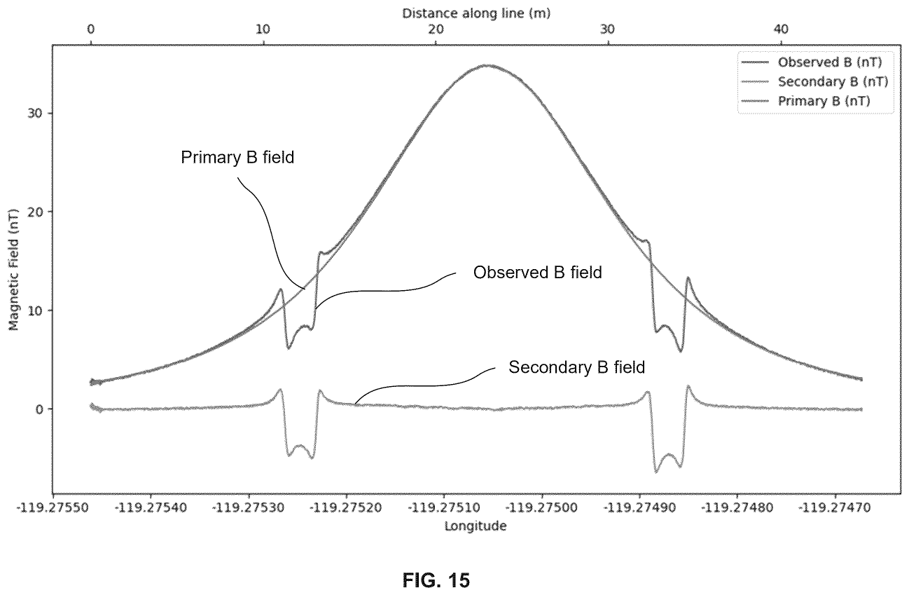

FIG. 15 shows the observed B field, the primary B field based on use of the analytical modeling code described above, and a removal of the primary field from the observed field to yield the secondary B field.

In summary, the major takeaways from this initial field test were: (1) Tx, Rx, and measurement control instrumentation were successfully field-tested and produced clean data that clearly showed the presence of the metallic targets; (2) The software for measurement control, data management, and data processing successfully performed as designed, providing real-time delivery of results to end users; and (3) The model-based removal of the primary field from the measurements was effective for this dataset.

The high precision clocks used by both the Tx and Rx platforms maintained accurate timing, enabling measurement of relative phase between the Tx and Rx signals without a wired connection.

Both the Tx and Rx GPS modules provided real-time kinematics (RTK) for positioning with centimeter-accuracy and provided additional timing correction. Such accurate positioning allowed for determination of the secondary field based on geometric calculations of the primary field, B_{primary}, which could then be subtracted from the total field, Bₜₒₜₐₗ, to find the secondary field, B_{secondary}.

### Additional Teachings and Remarks

The frequency-domain EMI geophysical systems and methods of the embodiments of the present invention are particularly well suited to deployment on airborne platforms (e.g., UAS), as no contact with the ground is required and allows for multi-scale characterization and as phase preservation can be maintained thus allowing removal of umbilical connections between Tx and Rx modules. In principle, EMI receivers could be deployed on swarms of UAS, with receivers on multiple UAS and a single transmitter on a single UAS, which could be airborne, ground-based, or semi-airborne, moving by air from one ground location to another. In conventional COTS (Commercially available off-the-shelf) EMI systems, transmitters and receivers are physically connected, thus constraining surveys to connected Tx and Rx modules (e.g., a single-drone systems with linked Rx and Tx functions. Embodiments of the present invention enable enormous opportunities to enhance and automate the acquisition of EMI geophysical data. The advancements in instrumentation and software, presented herein provide EMI instrumentation in which the transmitter and receiver are physically independent while still allowing phase preservation for full frequency-domain EMI data to be rapidly gathered and analyzed.

The enhancements provided by embodiments of the present invention may be applied to numerous geophysical characterization applications including for example: (1) fossil energy exploration and development, (2) mineral resource exploration and development, (3) water-resource management, (4) environmental monitoring, and (5) environmental remediation, and the like. For geophysical characterization and monitoring, the prospect of programming highly repeatable and low-cost drone missions for subsurface imaging allows for deployments in hazardous and previously inaccessible areas. Coupled with autonomous workflows for data processing, management, and visualization, drone-based geophysical characterization and monitoring enables unprecedented, real-time insight into diverse subsurface properties and processes of scientific and engineering importance.

Any materials referenced herein are incorporated herein by reference as if set forth in full. To the extent that any definitions or other teachings set forth in material incorporated herein by reference contradict teachings set forth directly herein (i.e., not incorporated by reference), the order of precedence given to the definitions or other teachings are: (1) teachings set forth directly in the body of the application, (2) teachings set forth in any appendix filed herewith, and then (3) teachings set forth in any other incorporated material with incorporated materials having more recent dates taking precedence over incorporated materials having older dates.

It is intended that the aspects of the invention set forth specifically herein or otherwise ascertained from the present teachings represent independent invention descriptions which Applicant contemplates as full and complete, and that Applicant believes may be set forth as independent claims without need of importing additional limitations or elements from other embodiments or aspects set forth herein for interpretation or clarification. It is also understood that any variations of the aspects (as well as variations in any embodiments) set forth herein represent individual and separate features that may be added to other claims to further define an invention being claimed by such claims.

While various preferred embodiments of the invention are shown and described, it is to be distinctly understood that this invention is not limited thereto but may be variously embodied in practice within the scope of the following claims. From the foregoing description, it will be apparent that various changes may be made without departing from the spirit and scope of the invention.

### REFERENCE TO ATTACHED APPENDIX

Additional information about implementations and embodiments of the invention are set forth in the attached appendix which is incorporated herein by reference:
Appendix A: A draft manuscript entitled “New drone-based electromagnetic instrumentation and AI-based processing for rapid subsurface characterization and monitoring for critical-mineral and environmental applications”.

1. An electromagnetic induction (EMI) system for characterizing geophysical environments, comprising:
a. a transmitter module comprising a transmission coil and signal transmission electronics; and
b. at least one receiver module comprising a receiver coil and signal reception electronics wherein the at least one receiver module is physically separated from the transmitter module without a wired signal connection between them, and
wherein phase information of signals sent by the transmitter module and those received by the at least one receiver module is preserved such that phase information may be used in characterizing the geophysical environment.

2. The EMI system of claim 1 wherein the transmitter module and the at least one receiver module together comprise clocks operating at frequencies and having accuracies no less than that necessary to enable sufficient preservation of the phase information for its use in characterizing the geophysical environment.

3. An electromagnetic induction (EMI) method for characterizing geophysical environments, comprising:
a. providing an EMI system, comprising
i. a transmitter module comprising a transmission coil and signal transmission electronics;
ii. providing at least one receiver module comprising a receiver coil and signal reception electronics wherein the at least one receiver module is physically separated from the transmitter module without a wired signal connection between them;
b. operating the EMI system for data gathering
c. preserving phase information of signals sent by the transmitter module and received by the at least one receiver module during data gathering; and
d. using the preserved phase information in characterizing the geophysical environment.

4. The EMI method of claim 3 wherein the transmitter module and the at least one receiver module together comprise clocks operating at frequencies and having accuracies no less than that necessary to enable sufficient preservation of the phase information for its use in characterizing the geophysical environment, and wherein the method includes using the clocks during data gathering.

5. The method of claim 4 wherein the clocks are GPS informed clocks.

6. The EMI method of claim 4 wherein the clocks have operating frequencies selected from the group consisting of: (1) at least 2 times a maximum transmitter frequency of a signal sent by the transmitter module that is to be received by the receiver coil of the at least one receiver module; (2) at least 4 times greater than a maximum transmitter frequency of a signal sent by the transmitter module that is to be received by the receiver coil of the at least one receiver module and used in characterizing the geophysical environment; (3) at least 8 times greater than a maximum transmitter frequency of a signal sent by the transmitter module that is to be received by the receiver coil of the at least one receiver module and used in characterizing the geophysical environment; (4) at least 16 times greater than a maximum transmitter frequency of a signal sent by the transmitter module that is to be received by the receiver coil of the at least one receiver module and used in characterizing the geophysical environment; (5) at least 32 times greater than a maximum transmitter frequency of a signal sent by the transmitter module that is to be received by the receiver coil of the at least one receiver module and used in characterizing the geophysical environment; (6) at least 64 times greater than a maximum transmitter frequency of a signal sent by the transmitter module that is to be received by the receiver coil of the at least one receiver module and used in characterizing the geophysical environment; and (7) at least 128 times greater than a maximum transmitter frequency of a signal sent by the transmitter module that is to be received by the receiver coil of the at least one receiver module and used in characterizing the geophysical environment.

7. The EMI method of claim 4 wherein the clocks comprise stable clocks and wherein the stable clocks operate with signal variations of less than 50 parts per billion.

8. The EMI method of claim 4 wherein at least one of the clocks comprises an atomic clock.

9. The EMI method of claim 8 wherein the atomic clock comprises a rubidium clock.

10. The EMI method of claim 4 wherein the operating frequency of the clock is greater than 10 MHz with a stability more accurate than 10 parts per billion.

11. The EMI method of claim 3 wherein the EMI system additionally comprises a computer system that provides for communication with at least one of the transmitter module and the at least one receiver module and wherein communications between the computer system and the at least one of the transmitter module and the at least one receiver module occurs wirelessly.

12. The EMI method of claim 11 wherein the computer system provides for a function selected from the group consisting of: (1) data storage, (2) data analysis, (3) user input and output, (3) EMI system control, and (4) module movement.

13. The EMI method of claim 11 wherein the EMI system is programmed to provide for adaptive surveying wherein an initial survey plan is modified mid-survey in response to geophysical results that are obtained.

14. The EMI method of claim 3 wherein the transmitter module and the at least one receiver module each comprise a GPS and at least one spatial orientation sensor associated with the orientation of its respective coil which provides data for use in providing the geophysical characterization.

15. The EMI method of claim 3 wherein transmitter module further comprises a power amplifier that feeds the transmitter coil via an in-series resonating capacitor.

16. The EMI method of claim 3 wherein the receiver coil of the at least one receiver module sends received signals to an amplifier via an in-parallel resonating capacitor.

17. The EMI method of claim 16 wherein said in-parallel resonating capacitor is adjusted during operation to peak the response of the resulting parallel resonant circuit, consisting of the in-parallel resonating capacitor and the receiver coil.

18. The EMI method of claim 3 additionally comprising gathering data when the transmitter module and at least one of the at least one receiver module are separated by a distance selected from the group consisting of: (1) more than 10 feet during at least a portion of data gathering, (2) more than 20 feet during data at least a portion of data gathering, (3) more than 60 feet during at least a portion of data gathering, and (4) more than 100 feet during at least a portion of data gathering.

19. The EMI method of claim 3 wherein the at least one receiver module comprises N receiver modules that independently use signals from the transmitter module wherein N is selected from the group consisting of: (1) at least 2, (2) at least 3, (3) at least 5, (4) at least 7, and (5) at least 10.

20. An electromagnetic induction (EMI) system for characterizing geophysical environments, comprising:
a. an EMI system, comprising
i. a means for transmitting;
ii. a means for receiving that is physically separated from the transmitter module without a wired signal connection between them;
b. means for operating the EMI system for data gathering;
c. means for preserving phase information of signals sent by the means for transmitting and those received by the means for receiving during data gathering; and
d. means for using the preserved phase information in characterizing the geophysical environment.
